(19) United States
(12) Patent Application Publication
(10) Pub. No.: US 2026/0050947 A1
(43) Pub. Date: Feb. 19, 2026

(54) SYSTEM AND METHOD FOR FACILITATING MOBILE VENDORS TO ADVERTISE THEIR GOODS AND/OR SERVICES

(71) Applicant: Tammy NOLAN, Mandurah (AU)

(72) Inventor: Tammy NOLAN, Mandurah (AU)

(21) Appl. No.: 19/101,841

(22) PCT Filed: Aug. 9, 2023
(86) PCT No.: PCT/AU2023/050746

§ 371 Date: Feb. 6, 2025

(30) Foreign Application Priority Data
Aug. 11, 2022 (AU) 2022902275

(51) Int. Cl. G06Q 30/0251; G06Q 10/109

(52) U.S. Cl. CPC G06Q 30/0259; G06Q 10/109; G06Q 30/0264

(57) ABSTRACT

A computer-implemented system and method that enables mobile vendors of goods and/or services to advertise the future location regarding availability of their goods and/or services to consumers, in an effort to generate and/or increase sales of their products and/or services. The present invention finds particular application with respect to mobile vendors such as owners of food vans, pop-up food stores and market stall holders and enables such owners to alert customers regarding their proposed presence at specific geographic locations at particular dates and times.

### FIELD OF THE INVENTION

The present invention relates to a computer-implemented system and method that enables mobile vendors of goods and/or services to advertise the future location regarding availability of their goods and/or services to consumers, in an effort to generate and/or increase sales of their products and/or services. The present invention finds particular application with respect to mobile vendors such as owners of food vans, pop-up food stores and market stall holders and enables such owners to alert customers regarding their proposed presence at specific geographic locations at particular dates and times.

### BACKGROUND OF THE INVENTION

The ability of retail business owners (vendors) to effectively advertise their goods and/or services for sale to consumers is critical to the success of the vendor's business. For vendors offering goods and/or services from a fixed retail store address, this is a relatively straightforward task and is achieved with traditional forms of advertising including the internet, social media and signage.

One of the most effective means of generating sales and increasing profits is through vendors establishing trusted relationships with their customers, particularly local customers, thereby generating repeat business and sales. In this regard, studies have shown that customers prefer to develop a trusted relationship with their local vendors and tend to purchase goods and/or services from their trusted vendor in an effort to increase the likelihood that they will be offered goods and/or services that are of a consistent and acceptable quality.

Accordingly, most vendors of a fixed address are able to effectively develop trusted relationships with their customers, particularly local customers. However, the situation is more complicated with respect to vendors of no fixed address, who typically do not have access to, and therefore the benefit of, a repeat and/or local loyal customer base who visit them at a fixed, known location. Accordingly, mobile vendors require an effective system and method that enables them to predict demand for their goods and/or services, and also an effective means of alerting customers regarding their proposed presence at a particular geographic location in an effort to adequately manage their stock, attract new customers, promote sales and increase revenue.

The ability of vendors to achieve consistent sales is not only critical from the perspective of generating revenue but is also critical for effective planning and management of their orders to ensure that they don't order stock in excess or shortfall. In this regard, efficient stock ordering and management avoids the need to store any surplus stock and also provides vendors with the ability to adequately manage and meet customer demand for the goods offered for sale. However, fluctuations in sales are inevitable, and in an effort to avoid missing sales and/or disappointing their customers as a result of insufficient stock, most vendors tend to order at least some surplus stock to ensure they are able to meet customer demand. In most instances, this is not a problem for vendors of a fixed address since they usually have adequate facilities to store and maintain any surplus stock.

Mobile vendors are unable to readily store and/or transport surplus stock to the location at which they provide their goods and/or services, and therefore, tend to waste time, effort and resources in transporting excess stock. Alternatively, mobile vendors are unable to meet customer demand in instances where they fail to carry sufficient stock.

There is currently no effective system or platform available that enables mobile vendors to predict customer demand, adequately manage their stock and select geographical location(s) that provide the best prospects for generating maximum profits. This often results in wastage of goods, the offering of lower quality products and/or services to customers for sale, decreased revenue, and wasted resources (eg. fuel) and time.

Further, in the event customers have a positive experience with a particular mobile vendor and prefer to purchase additional goods and/or services from the same mobile vendor, currently the only means of locating a particular mobile vendor is by conducting internet searches and following the mobile vendor on social media. Such methods are time consuming and inefficient, and result in wastage of computer (processing and networking) resources.

The present invention seeks to mitigate the problems discussed herein, or at least seeks to provide an alternative solution to existing systems and methods for facilitating mobile vendors to advertise their goods and/or services.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for alerting individuals regarding the proposed presence of a mobile vendor at a specific geographic location at a particular date and time, the method including, receiving, by one or more processors, information from a plurality of mobile vendors including, details sufficient to identify each mobile vendor, goods and/or services provided by each mobile vendor, information for populating a multi-access calendar relating to the proposed presence of each mobile vendor at specific geographic locations on particular days and times, receiving, by one or more processors, information from one or more individuals including, details of one or more mobile vendors of interest, goods and/or services of interest, from goods and/or services offered for purchase by each of the registered mobile vendors of interest, enabling, by one or more processors, each of the one or more individuals to view the multi-access calendar populated with information regarding the proposed presence of mobile vendors of interest, and to record their interest in goods and/or services proposed to be offered by the mobile vendor(s) of interest at a specific geographic location on a particular day and time, providing, by one or more processors, one or more reports to the mobile vendors regarding any recorded interest from individuals with respect to goods and/or services proposed to be offered by the mobile vendors for purchase at specific geographic locations on particular days and times, enabling, by one or more processors, the mobile vendors to adjust, in the multi-access calendar, the information regarding their proposed presence at specific geographic locations on particular days and times based upon receipt of the one or more reports regarding recorded interest from the individuals with respect to the goods and/or services proposed to be offered for purchase; and automatically notifying, by one or more processors, the individuals who recorded their interest in attending a mobile vendor site at a specific geographic location at a proposed date and time regarding any adjustment made by the vendor with respect to any one or more of the location, date and time.

In an embodiment, based on an adjustment by the vendor regarding any one or more of the location, date and time, the method further includes, providing, by one or more processors, the individual with one or more alternative proposed presences of the mobile vendor at an alternative geographic location and/or an alternative date and/or time.

In an embodiment, the one or more reports provided to mobile vendors regarding any recorded interest with respect to goods and/or services proposed to be offered by the mobile vendors includes an indication of the number of individuals who have recorded their interest with respect to goods and/or services proposed to be offered by the mobile vendors for purchase at specific geographic locations on particular days and times.

In an embodiment, the one or more reports further include recommendations in relation to one or more of, adjustments recommended to the location, date and/or time based on the number of individuals who have recorded their interest, adjustments recommended to the location, date and/or time, based on historical data, adjustments recommended to the location, date and/or time based on information received from one or more external sources.

In an embodiment, the information received from the plurality of mobile vendors further includes the location(s) they are required to visit to (i) obtain stock, and (ii) attend in accordance with recorded interest from registered users at specific geographic locations, the one or more reports further including recommendations in relation to any one or more of, an amount of stock to purchase to cater for at least the number of individuals who have recorded their interest, an amount of stock to purchase that accounts for any adjustments made by the vendor to the location, date and/or time, and travel routes representing the most efficient travel path between said locations. It will be appreciated that this embodiment seeks to ensure that user (customer) demand is met with the most efficient travel between locations in which the mobile vendor proposes to attend and locations requiring the mobile vendor to attend to re-stock the mobile vendor's vehicle.

In an embodiment, the historical data includes stored data relating to previous selections of location, date and/or time by the mobile vendor, and the relative success regarding said selections including in relation to at least the number of individuals who purchased goods and/or services from the mobile vendor and/or the quantum of goods and/or services purchased. Accordingly, mobile vendors may receive a recommendation to adjust their proposed presences (or such adjustments may be made automatically) based upon the historical data indicating periods of high traffic and/or user population according to those users who have expressed previous interest in a mobile vendor and/or their goods and/or services.

In an embodiment, the information received from one or more external sources relate to external factors that could influence the number of visitors to the mobile vending site at the specified location and at the particular date and/or time.

In an embodiment, the information received from the one or more external sources includes any one or more of, weather information upon which the likelihood of an adverse weather event to occur at the specified location at the particular date and/or time is determined, event information upon which the propensity for an event held at or adjacent the specified location at the particular date and/or time is determined, works information upon which the propensity for works, including any construction work, proposed to be carried out at, or in close proximity to, the specified location at the particular date and/or time is determined. Works may include any additional works that give rise to a future planned disruption to particular geographic locations, eg. roadworks or repairs. Such roadworks or repairs may be due to, for example, repair of essential infrastructure (e.g. gas, electricity, communications) thereby enabling the mobile vendors to consider such disruptions when selecting geographic locations.

In an embodiment, the information received from the one or more individuals further includes a geographic location of the one or more individuals.

In an embodiment, the method further includes providing, by one or more processors, individuals who have previously expressed interest in a mobile vendor and/or the goods and/or services of the mobile vendor with an alert or notification regarding the proposed presence of the mobile vendor in instances where the mobile vendor's proposed presence includes a location within a predetermined vicinity of the individual's geographic location (irrespective of whether the individual has expressed prior interest in the particular day/time).

In an embodiment, the alert or notification is any one or more of an email, text message, and/or push notification.

In an embodiment, the information provided by the plurality of mobile vendors includes a category of mobile vendor, and a category of goods and/or services provided by the mobile vendor.

In an embodiment, the method further includes, providing, by one or more processors, individuals with a search facility to enable keyword searching for mobile vendors.

In an embodiment, the search facility enables filtering of search results according to any one or more of, category of mobile vendor, goods and/or services offered by mobile vendors, category of goods and/or services, a date on which the individual proposes to purchase goods and/or services from a mobile vendor, a time period during which the individual proposes to purchase goods and/or services from a mobile vendor, a time at which the individual proposes to purchase goods and/or services from a mobile vendor, and location, date and/or time of the proposed presences of mobile vendors.

In an embodiment, any adjustment(s) made by the vendor regarding any one or more of the location, date and time of a proposed presence are reflected in the multi-access calendar in substantially real-time.

In an embodiment, the multi-access calendar is viewable by the individuals, and thereby enables the individuals to view the proposed presence(s) of mobile vendors of interest including any adjustments to the proposed presences, the multi-access calendar further enabling the individuals to access an associated interactive map that displays a geographic area including the location of the proposed presence(s) reflected in the multi-access calendar, wherein any adjustment made by the vendor in relation to the location of the proposed presence(s) is also reflected in the interactive map in substantially real-time.

In an embodiment, the interactive map further enables individuals to search for additional mobile vendors having proposed mobile vending presences within a particular geographical area, including by allowing the individual to manually adjust the geographical area viewable on a display of a data communications device associated with the individual, and to search within the geographical area currently displayed.

In an embodiment, the method further includes providing, by one or more processors, a sharing facility allowing individuals to share with other individuals any one or more of, interest in goods and/or services of a mobile vendor at a specified geographic location and at a particular day and time, an intention to purchase goods and/or services from a particular mobile vendor at a specified geographic location and at a particular day and time, and their experiences with purchasing goods and/or services from particular mobile vendors. In this way, a “social network” of users may be formed according to their interests and preferences regarding mobile vendors in their local geographic area.

In another aspect, the present invention provides a computer-implemented system for alerting individuals to the proposed presence of a mobile vendor at a specific geographic location at a particular date and time, the system including one or more processors operable to receive information from a plurality of mobile vendors including, details sufficient to identify each mobile vendor, goods and/or services provided by each mobile vendor, information for populating a multi-access calendar relating to the proposed presence of each mobile vendor at specific geographic locations on particular days and times, receive information from one or more individuals including, details of any one or more mobile vendors of interest, goods and/or services of interest, from goods and/or services offered for purchase by each of the registered mobile vendors of interest, enable each of the one or more individuals to view the multi-access calendar populated with information regarding the proposed presence of mobile vendors of interest, and to record their interest in goods and/or services proposed to be offered by the mobile vendor(s) of interest at a specific geographic location on a particular day and time, provide one or more reports to the mobile vendors regarding any recorded interest from individuals with respect to goods and/or services proposed to be offered by the mobile vendors for purchase at specific geographic locations on particular days and times, enable the mobile vendors to adjust, in the multi-access calendar, the information regarding their proposed presence at specific geographic locations on particular days and times based on receipt of the one or more reports regarding recorded interest from the individuals with respect to the goods and/or services proposed to be offered for purchase, and automatically notify the individuals who recorded their interest in attending a mobile vendor site at a specific geographic location at a proposed date and time regarding any adjustment made by the vendor regarding one or more of the location, date and time.

In yet another aspect, the present invention provides a non-transitory computer-readable medium including computer instruction code that, when executed on a computer, causes one or more processors to perform the steps of, receiving information from a plurality of mobile vendors including, details sufficient to identify each mobile vendor, goods and/or services provided by each mobile vendor, information for populating a multi-access calendar relating to the proposed presence of each mobile vendor at specific geographic locations on particular days and times, receiving information from one or more individuals including, details of one or more mobile vendors of interest, goods and/or services of interest, from goods and/or services offered for purchase by each of the registered mobile vendors of interest, enabling each of the one or more individuals to view the multi-access calendar populated with information regarding the proposed presence of mobile vendors of interest, and to record their interest in goods and/or services proposed to be offered by the mobile vendor(s) of interest at a specific geographic location on a particular day and time, providing one or more reports to the mobile vendors regarding any recorded interest from individuals with respect to goods and/or services proposed to be offered by the mobile vendors for purchase at specific geographic locations on particular days and times, enabling the mobile vendors to adjust, in the multi-access calendar, the information regarding their proposed presence at specific geographic locations on particular days and times based on receipt of the one or more reports regarding recorded interest from the individuals with respect to the goods and/or services proposed to be offered for purchase, and automatically notifying the individuals who recorded their interest in attending a mobile vendor site at a specific geographic location at a proposed date and time regarding any adjustment made by the vendor regarding any one or more of the location, date and time.

In a still further aspect, the present invention provides a portable electronic device for use by a mobile vendor of goods and/or services to alert individuals to the proposed presence of the mobile vendor at a specific geographic location at a particular date and time, the device including, a touch screen configured to receive an input corresponding to a touch operation of the user on an area of the touch screen, and a processor connected to the touch screen, wherein the processor is configured to detect the input to the touch screen and perform operations including, accessing a database storing, details of one or more mobile vendors of interest to one or more individuals, goods and/or services of interest to the one or more individuals, from goods and/or services offered for purchase by each of the registered mobile vendors of interest, recorded interest in goods and/or services proposed to be offered by the mobile vendor(s) of interest to the one or more individuals at a specific geographic location on a particular day and time, detecting a first input, via the touch screen, of information from the mobile vendor including, details sufficient to identify the mobile vendor, goods and/or services provided by the mobile vendor, information for populating a multi-access calendar relating to the proposed presence of the mobile vendor at specific geographic locations on particular days and times, the multi-access calendar viewable by the one or more individuals on their data communication devices, detecting a second input, via the touch screen of a request to access one or more reports regarding any recorded interest from individuals with respect to goods and/or services proposed to be offered by the mobile vendor for purchase at specific geographic locations on particular days and times, processing the request and providing, for display on the touch screen, the one or more reports, providing, for display on the touch screen, a prompt and/or recommendation for the mobile vendor to adjust, in the multi-access calendar, the information regarding their proposed presence at specific geographic locations on particular days and times based on receipt of the one or more reports regarding recorded interest from the individuals with respect to the goods and/or services proposed to be offered for purchase, and causing notifications to be issued to the individuals who recorded their interest in attending the mobile vendor site at a specific geographic location at a proposed date and time regarding any adjustment made by the mobile vendor regarding any one or more of the location, date and time.

### BRIEF DESCRIPTION OF THE DRAWINGS

Embodiments of the invention will now be described in further detail with reference to the accompanying Figures in which:

FIG. 1 provides an overview of a system according to an embodiment of the present invention showing, in particular, the interaction between various system components;

FIG. 2 illustrates a diagram associated with an exemplary server component within the system illustrated in FIG. 1;

FIG. 3 illustrates an exemplary flow diagram of a process that enables a mobile vendor to download and install a software application and subsequently access, or register to use, the software application for interaction with the system illustrated in FIG. 1;

FIG. 4 illustrates an exemplary flow diagram of a process that enables each mobile vendor to provide details regarding any additional vendor businesses;

FIG. 5 illustrates an exemplary flow diagram of a process that enables each mobile vendor to provide their proposed presence at a specific geographical location on a particular day and time using a multi-access calendar, and for individuals to register and use the application to provide details of vendors of interest including to access the multi-access calendar and record their interest in a particular vendor presence;

FIG. 6 illustrates an exemplary flow diagram of a process that enables a mobile vendor to view a report regarding recorded interest from individuals, and proceed to vend at the particular location on the particular days and times indicated as being of most interest to individuals; and

FIG. 7 illustrates a diagram associated with exemplary interfaces of the software application including an alert/notifications interface and a chat interface.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth to provide a better understanding of the present disclosure. It will be readily apparent, however, that the current disclosure may be practiced without limitation to the specific details. In other instances, some methods and structures have not been described in detail to avoid obscuring the present disclosure.

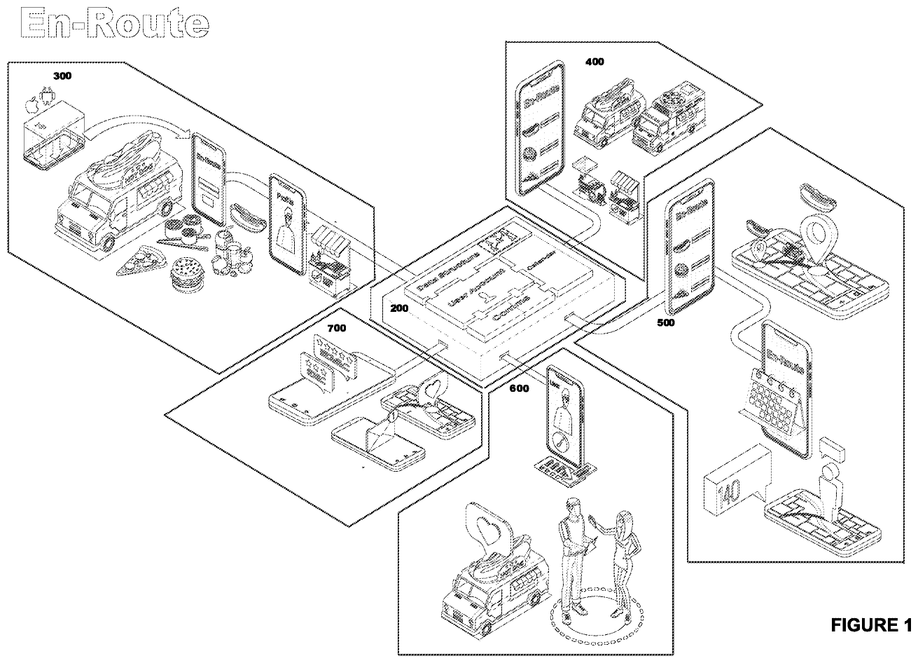

An embodiment of the invention includes at least a computer-implemented system and method for facilitating registered mobile vendors (30) to alert registered users (e.g. individuals (90)) of their proposed presence at a specific geographic location (70) at a particular date and time, as depicted in FIG. 1. The system and method of the described embodiment provide a platform that hosts a computer-executable software application (40), wherein the application (40) is accessible by the registered mobile vendors (30) and the individuals (90). The platform further enables the generation of notifications to individuals (90) who have expressed interest in attending a mobile vendor site at a specific geographic location at a proposed date and time, in circumstances where the vendor (30) has adjusted their proposed presence at that specific geographic location and/or at that particular date and time. The platform still further enables reports to be generated and displayed to the mobile vendors (30) regarding recorded interest from individuals (90) with respect to goods and/or services (35) offered by the mobile vendors (30) for sale at specific geographic locations on particular days and times, thereby enabling the mobile vendors (30) to adjust their proposed presence (and other variables such as stock, etc.) according to the recorded interest.

The platform is provided by a central server (20) which maintains one or more processors and/or databases for performing functions, including receiving information from registered mobile vendors (30) that enables each mobile vendor (30), and the goods and/or services provided by each mobile vendor (30), to be identified. The server (20) is further configured to receive further information from each mobile vendor (30) regarding their proposed presence at specific geographic locations (70) on particular days and times, wherein the further information may be included in a multi-access calendar (80). The server (20) is also configured to receive details from registered individuals (90), including identity information of one or more registered mobile vendors (30) that are of interest to the individuals (90), as well as goods and/or services (35) as provided by each registered mobile vendor (30) of interest, thereby enabling each individual (90) to view, for example in the multi-access calendar (80), the proposed presence of mobile vendors (30) at various specific geographic locations (70) at particular days and times.

The person skilled in the relevant field of technology will appreciate that the platform provides a solution to existing problems associated with the wastage of time, effort and resources associated with the transportation of excess stock by mobile vendors (30), and/or the inability of mobile vendors (30) to meet customer demand in instances where they fail to carry sufficient stock. By understanding an interest in their proposed presence, and an estimated number of individuals (90) who are likely to purchase goods and/or services on a particular day and time at a particular location (70), the vendor (30) may stock accordingly, and generally be better prepared for the proposed vending. Furthermore, the platform provides individuals with the ability to quickly and efficiently locate particular mobile vendors (30) of interest, or vendors located within a particular geographical location, as well as access to a dynamic multi-access calendar (80) associated with different vendors (30).

In view of the above practical and useful results that arise from this implementation of the present invention, the use of a data communications device (50) on which the software application (40) operates, in combination with the server (20) and the functionality thereof, which gives rise to the abovementioned practical and useful effects represents an advance as compared with previously known hardware and/or techniques for addressing the same or similar problems.

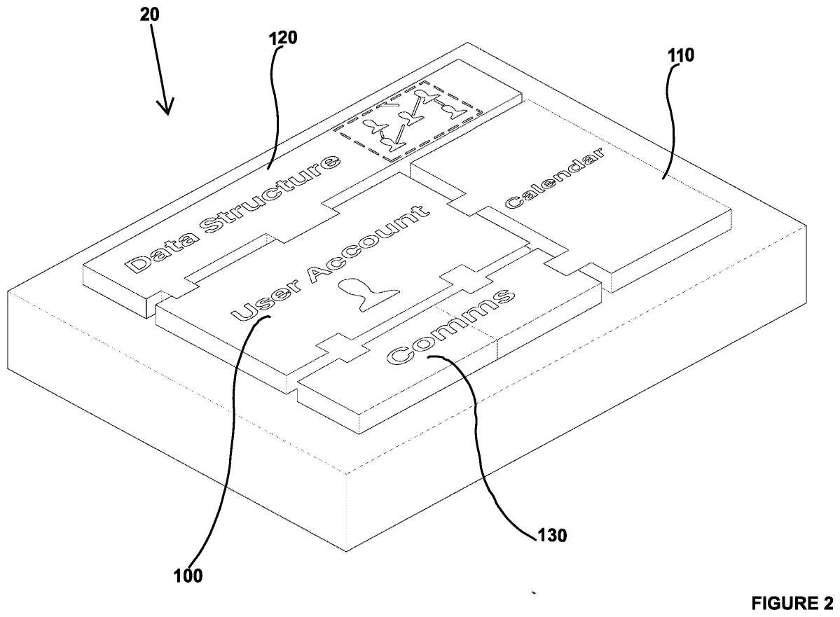

FIG. 1 is divided into segments which are further expanded in subsequent FIGS. 2-7. In particular, Segment 200 of FIG. 1 shows the server component (20) with which a software application (40) operating on data communication devices (50) of the mobile vendors (30) as well as individual users (90) are configured to communicate. It will be apparent to the person skilled in the relevant field of technology that the software application (40) may be a mobile application or a web application, and similarly, the device (50) utilised by each user may be a portable device such as a mobile phone or laptop, or alternatively a fixed location device such as a personal computer (not shown). The server component (20) is additionally detailed in FIG. 2.

The skilled person will appreciate that the steps described herein may be executed by the device (50), wherein such operations are facilitated by the software application (40) operating on each device. According to another implementation of the present invention, the server (20) is programmed to provide most or all of the functions described herein particularly where they cannot be provided locally on the user devices (50) or where it may be impractical or not commercially viable to do so. In other words, the steps described herein as performed by the device (50), or components thereof, may be associated with hardware that is located externally of the devices, such as the remote central server (20) for example (i.e. in a distributed architecture). Different arrangements are possible in this regard, and alternate variations will be apparent to the person skilled in the relevant field of technology.

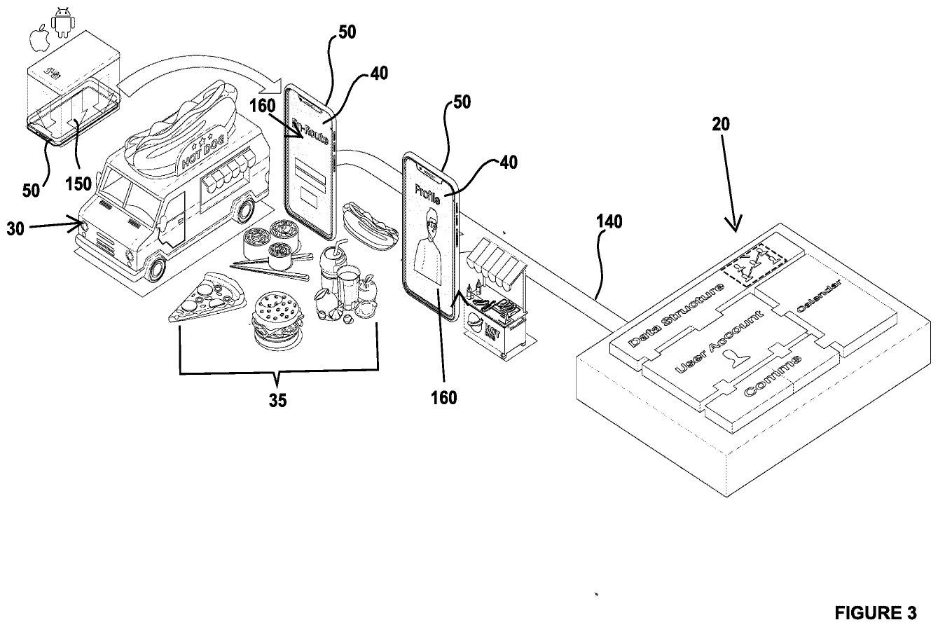

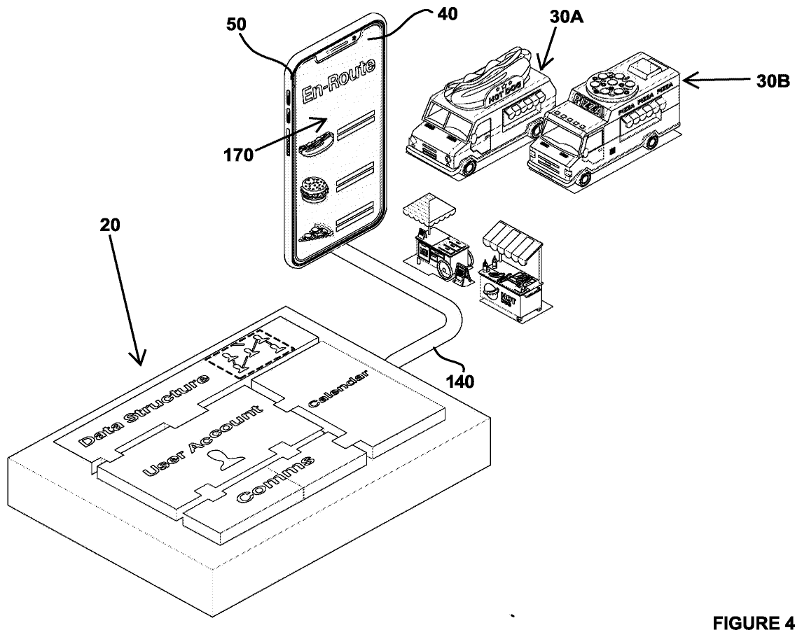

Segment 300 of FIG. 1 shows how the server (20) may be configured for communication with the devices (50) associated with mobile vendors (30) as well as individuals (90), as further detailed in FIG. 3 (although FIG. 3 illustrates solely the mobile vendor (30)). In one example, the server (20) may receive data from the devices (50) for the purpose of creating a user and/or vendor business profile, e.g. based upon the entry of details from vendors (30) or individuals (90). Segment 300 of FIG. 1 further shows a mobile vendor (30) downloading and installing the application (40) and subsequently accessing an interface (160) the application (40) to establish a user account and vendor business profile. Segment 400 of FIG. 1 shows an example interface (170) which enables mobile vendors (30) to create multiple vendor business profiles in circumstances where the particular vendor (30) may operate one or more additional vendor businesses (60), as further detailed in FIG. 4.

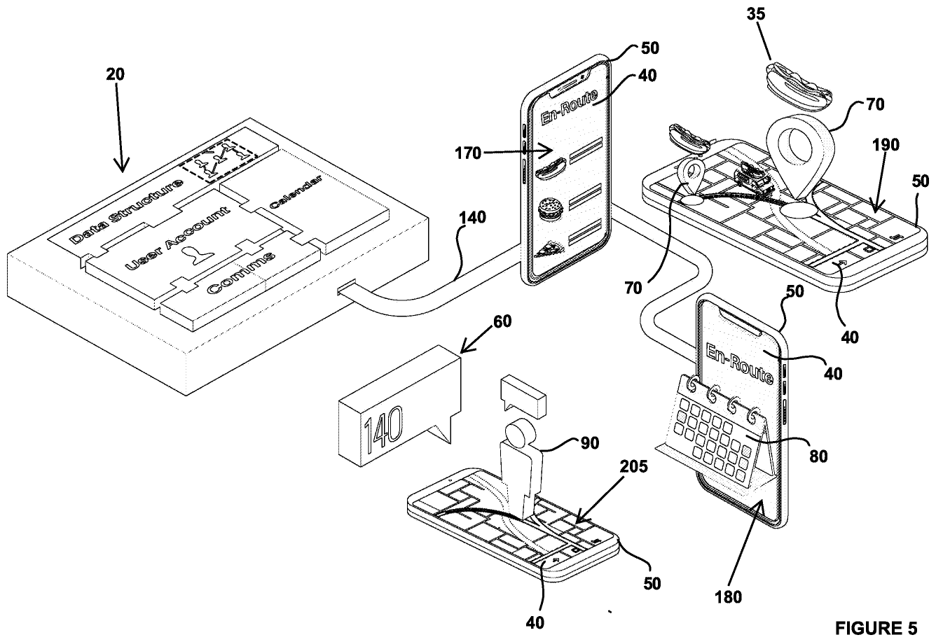

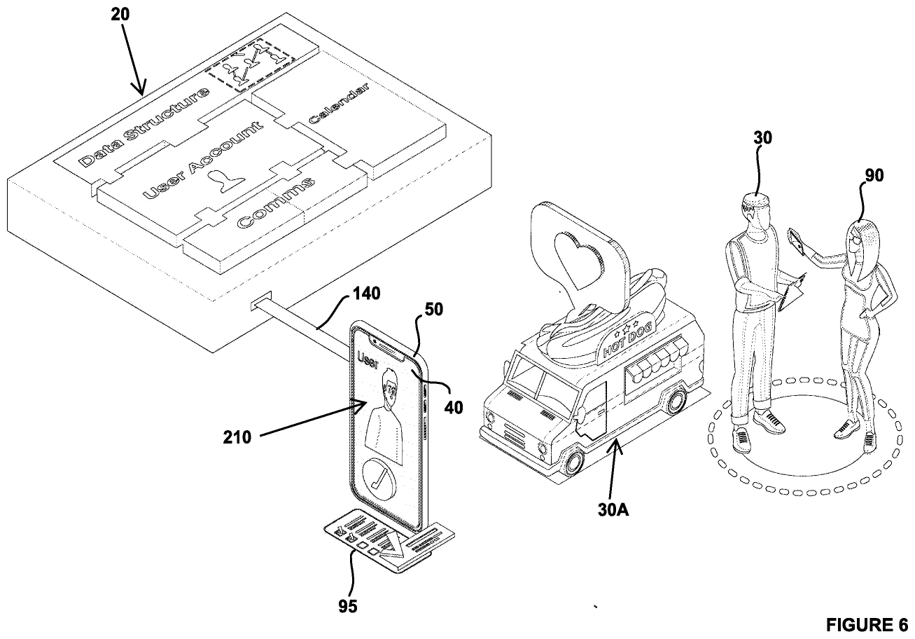

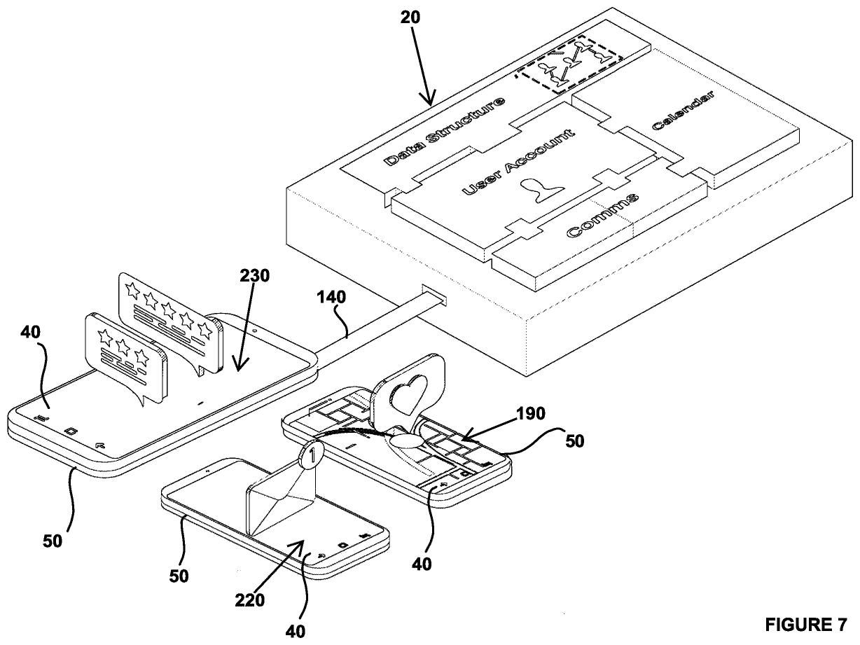

Segment 500 of FIG. 1 shows additional example interfaces including a multi-access calendar interface (180) and various map interfaces (190) and (205), as further detailed in FIG. 5. Segment 600 of FIG. 1 shows an example interface (210) in which a report (95) outlining recorded interest is presented to a mobile vendor (30) which may affect the mobile vendor's decision to operate at a specific geographic location (70) on a particular day and time. Segment 600 of FIG. 1 further illustrates a mobile vendor (30) committing to a particular location (70) and engaging in sales of goods and/or services at the particular location (70) to individual users (90), as further detailed in FIG. 6. Segment 700 of FIG. 1 shows additional interfaces (220) and (230) in which additional functionality associated with the software application (40) may be accessed by vendors (30) and individuals (90), as further detailed in FIG. 7.

As described above, FIG. 2 shows in greater detail the Segment 200 of FIG. 1 and, in particular, FIG. 2 shows the server component (20) which includes infrastructure upon which the platform of the present invention operates. The infrastructure may be local or cloud-based. The central server (20) may operate one or more computer processors and maintain one or more databases to enable the following functionality and/or storage:
User account register (100) storing details relating to mobile vendors (30) as well as registered individuals (90) (e.g. name, address, contact details and any additional detail which may be relevant for the purpose of identifying each user). In the case of mobile vendors (30), register (100) may include additional details relating to the goods/services (35) made available for purchase by the vendors (30), and in the case of registered individuals (90), the stored details may further include the user's preferred selection of vendors (30) as well as goods and/or services (35) of interest, wherein such details may be requested of and submitted by each user during an initial registration process;
Calendar functionality (110) for managing a multi-access calendar (80) provided to users in interface (180), the functionality (110) operable to receive input from the mobile vendors (30) with respect to location (70) and day/time of vending, input from individuals (90) regarding their interest in attending the particular location (70) for purchasing goods and/or services from the vendor (30), as well further input from vendors (30) regarding any adjustments to be made to the location (70) and/or day/time in view of updates with respect to the recorded interest from individuals (90);
Data structure (120) for linking (providing relationships between) individual sets of data stored in the account register (100), including relationships between vendors (30), goods/services (35) sold by vendors (30), individuals (90) who have recorded interest in particular goods and/or services (35), vendors of interest to individuals (90), calendar locations/days/times, etc, to enable efficient interrogation and location of such data upon request, particularly during the process of notifying individuals (90) regarding adjustments made by vendors (30) in order to provide alternative presences of the vendor (30). The efficient location of data through the data structure (120) also assists searching for vendors (30) conducted by individuals (90), e.g. through map interface (190);
Communications functionality (130) for providing a live chat facility between vendors (30) and individuals (90), and any additional related communications as required.

FIG. 2 also depicts that server (20) is configured to enable communication (140) with the devices (50) and, in particular, the software application (40) operating on each device (50). Such communications may occur via the internet or similar network.

FIG. 3 shows in greater detail Segment 300 of FIG. 1 and, in particular, the steps associated with a vendor (30) installing (150) the software application on their device (50), and subsequently accessing a user login and registration interface (160) associated with the software application. Such access may be granted after the vendor (30) has installed the application (40) which may be achieved by downloading the application (40) from an application store. Each vendor (30) may create an account (which may include a vendor business profile) using the application (40) and the account/profile information may be stored in the user account register (100).

A similar installation and registration process may apply equally to individuals (90) seeking to register to use the application (40) to record their interest in particular vendors (30) and/or goods/services (35) provided by vendors (30), including to ‘follow’ vendors and keep track of where particular vendors will be located on particular days and times.

Accordingly, once a vendor (30) has accessed the application (40), the vendor (30) may be presented with interface (160) that allows the vendor (30) to create a business profile that will subsequently enable other registered individuals (90) to view information about the vendor (30).

FIG. 4 shows in greater detail Segment 400 of FIG. 1 and, in particular, a scenario in which a single vendor (30) operates multiple mobile vendor businesses (30A) and (30B). In the example shown, the primary vendor business (30A) is a mobile hotdog vehicle, and the additional vendor business (30B) is a mobile pizza vehicle, although it is to be understood that a vendor (30) may operate different businesses as compared with those illustrated in the embodiments herein. In addition, more than two businesses may be operated.

The interface (170) shown in FIG. 4 is a vendor business listing/editing interface (170) enabling each vendor (30) to view their business listing(s) and allows the vendor (30) to maintain and manage their individual business profiles including to update goods and/or services (35) sold through each individual business, as well as associated pricelists, etc. In this regard, the vendors (30) may be prompted to also specify a category of goods and/or services (35) such that individuals (90), when searching for vendors (30), may search for vendors (30) according to the category of the goods and/or services (35) provided along with other search criteria such as the name of the vendor, particular goods and/or services (35) sold by vendors, geographical location, etc.

FIG. 5 shows in greater detail Segment 500 of FIG. 1 and, in particular, various example interfaces that may be utilised by the vendor (30) as well as individuals (90) in order to manage and keep track of adjustments to a multi-access calendar (80) utilised by the vendor (30) to publish particular presences of the vendor (30) at particular locations (70) and on particular days/times. For example, interface (180) of FIG. 5 presents the multi-access calendar (80) to the vendor (30) to thereby enable the vendor (30) to input details relating to a proposed location (70) and a proposed day/time of vending, and subsequently make adjustments based upon recorded interest from other individuals (90).

Once a vendor (30) has posted an entry in the multi-access calendar (80), such information may be viewable by individuals (90) through, for example, interface (190) which displays an interactive map so that individuals (90) may visualize the precise location or locations (70) at which the mobile vendor (30) is proposing to vend on a particular day and/or time (or time period). For example, a particular individual (90) may be ‘following’ a particular mobile vendor (30), and on a daily basis, the interactive map shown in interface (190) may be updated with new details relating to the proposed location of the mobile vendor (30).

In addition to indicating a proposed location, the real-time location of mobile vendors (30) may also be tracked by individuals (90). This may be particularly useful in circumstances where a mobile vendor (30) is constantly moving, eg. an ice cream truck (not shown).

Individuals (90) may also be provided with a search facility that enables searching for particular mobile vendors (30), or categories of goods and/or services (35) sold by different vendors (30), and indeed any search filter may be applied by individuals (90) in order to more precisely locate particular vendors of interest. In one example, an individual (90) may have a particular interest in fast food, and one particular search category may include “fast food” which, once selected by an individual (90), may shortlist the search results to indicate only those vendors (30) selling fast food products in particular. Another example of a search may relate to the functionality of the interactive map (80) shown in interface (190), where a user (90) may search for vendors located within a particular geographical region, wherein the particular region that may be selected by making adjustments to the searchable geographical area using the device touch screen. The present invention is not limited to any one particular search criteria, and it is to be understood that the search facility may provide multiple different search options to individuals (90) seeking to locate a vendor (30) of interest. In another example, the individual (90) may have heard of a particular vendor's name and the search facility may provide a field in which particular key words associated with a vendor of interest may be entered.

When an individual (90) selects to ‘follow’ a mobile vendor, then they may subsequently receive notifications and/or alerts regarding the particular movements of the mobile vendor (30), including a present location as well as proposed future locations, as described in greater detail further below.

Mobile vendors (30) may also be provided with information relating to recorded interest relating to their proposed presence (location/day/time), as shown by way of example in the interactive map of interface (205) shown in FIG. 5. In the example shown, the vendor (30) is able to view their proposed location (70) within the interactive map and also be shown (via display (60)) a number (e.g. 140 as shown in FIG. 5) of individuals (90) who have recorded an interest in attending at the location on the particular day/time (or time period) in order to purchase goods and/or services (35) from the vendor (30). In this way, the skilled addressee will appreciate that vendors (30) may be provided with an indication of the number of individuals (90) who have an interest in their offering at a particular location and on a particular day/time (or time period) in order to enable the vendor (30) to make a commercial assessment regarding whether their presence at the location will be profitable, or whether an adjustment may be appropriate.

In this regard, vendors (30) may also be provided with an option to select multiple proposed locations on the interactive map (205) in order to enable their followers, or any other registered individuals (90), to indicate their interest with respect to the particular proposed locations (70). Since the map provides the vendor (30) with multiple options, with an indication of the interest of individuals in relation to each location option, it will be appreciated that this facility enables the vendor (30) to select a location (70) from the multiple options that is most likely to provide them with the most profitable outcome on any one particular date or time (or time period).

By receiving such information, vendors (30) are also assisted with respect to determining an appropriate amount of stock to purchase and/or maintain to ensure minimal wastage with respect to time and resources in transporting excess stock, and will reduce instances in which the vendor (30) fails to carry sufficient stock, since the approximate number of customers will be known in advance. Essentially, the interactive map shown in interface (205) enables the mobile vendor (30) to predict customer demand.

FIG. 6 shows in greater detail Segment 600 of FIG. 1 and, in particular, an interface (210) in which a report (95) may be generated and presented to the mobile vendor (30) regarding recorded interest from other registered individuals (90) with respect to goods and/or services (35) offered by the mobile vendor (30) for sale at geographic locations on particular days and times.

It is to be understood that other factors may also influence the decision made by vendors (30) to select a particular location/date/time, including for example based upon real-time analytical information that provides mobile vendors (30) with information regarding expected traffic and/or user population according to the particular geographic location (70), time and date, thereby enabling the mobile vendor (30) to adjust (if necessary) their proposed presence entries in the access calendar (80) to more closely accord with periods of high traffic and/or user population. Such analytical information may be presented to the vendor (30) in one or more of interfaces (180), (205) and (210), for example.

In addition, vendors (30) may receive details from external sources regarding future planned disruptions at particular locations (70) according to planned roadworks, repairs, or the like. Such roadworks or repairs may be due to, for example, repair of essential infrastructure and the receipt of details of same may enable the mobile vendors (30) to consider proposed disruptions in particular geographic locations (70). Again, such information may be obtained and then presented to the mobile vendors (30) in, for example, one or more of interfaces (180), (205) and (210).

Yet another factor which may influence the vendor's location selections includes the location(s) from which stock is obtained by the vendor (12), and the particular travel routes that are available between the stock location and proposed vending location(s). In this regard, vendors (12) may provide details regarding the locations they are required to visit to obtain stock, and part of the information/recommendations provided to the vendors (30) may include recommended travel routes representing the most efficient travel paths between such locations. It will be appreciated that such a facility seeks to ensure customer demand is met with the most efficient travel between locations in which the mobile vendor (30) proposes to attend and locations requiring the mobile vendor (30) to attend to re-stock the mobile vendor vehicle.

FIG. 7 shows in greater detail Segment 700 of FIG. 1 and, in particular, example interfaces that are generated based upon adjustments made to the multi-access calendar (80). In particular, in the example shown, mobile vendor (30) makes an adjustment using the interactive map shown in interface (190) to the location (70) at which the vendor (30) proposes to be trading on a particular day/time, with interface 220 subsequently presented to individuals (90) to automatically notify the individuals (90) who have expressed an interest in attending at the mobile vendor site on the proposed date and time, that the vendor (12) has adjusted their location (70) or other detail regarding their presence. The adjusted detail may relate to location (70), date, or period of time trading, or may relate to other features such as food specials that are available on that day only, changes to menu items, etc. In this regard, a push-notification may be provided to users (90) regarding the adjusted detail(s).

In circumstances where a registered individual (90) has not necessarily expressed an interest in a particular day/time of trading by a mobile vendor (30) in which they have an interest, but where the new location selected by the vendor (30) is within a geographical vicinity of the registered user (90), the user (90) may receive a push-notification alerting them to the trading location given that the location is within close vicinity of the individual (90).

Where details relating to location, date and/or time have been updated by the mobile vendor (12), but where the vendor is yet to propose/select a new location, date and/or time, multiple alternative options regarding location, date and/or time may be presented to the individual (90) in order to gauge user interest in such proposals (e.g. proposals based upon previous sites at which the vendor has been located, or previous time periods in which the vendor experienced improved trading). Such a facility will provide individuals (90) with the ability to record further interest in particular alternative locations (70), dates and/or times which the vendor (12) may take into consideration when selecting a new location (70), date and/or time.

The proposals/recommendations that are presented to vendors (30) or registered individuals (90) as described herein may also be based upon historical data collected over time, including in relation to locations, dates and/or times that proved most profitable to the vendor (30) as compared with other locations, dates and/or times.

Any updates to any one of the location, date and/or time may be automatically reflected in the multi-access calendar (80) which may be accessed by vendors (30) as well as individuals (90) such that the calendar (80) represents the most up to date source of information available to all registered users. When any information in the calendar (80) is updated, then the alerts/notification interface (220) may provide relevant notification regarding such updates to interested registered individuals (90).

FIG. 7 also shows a further interface (230) enabling communications between relevant parties, including between individuals (90) and mobile vendors (30). Such communications may relate to a proposed trading presence proposed by the mobile vendor (30). Another example of communications between individuals (90) and vendors (30) may include comments regarding the experience of individuals with a particular mobile vendor (30), with the particular location (70), day and time of the experience being recorded. Such comments may be shared with other registered individuals (90). Communications may also occur between registered individuals (90), e.g. to share their intention to obtain goods and/or services (35) from a particular mobile vendor (30), thereby effectively forming a “social network” of users according to their location, interests and/or preferences.

The interface (230) may also provide additional functionality, including for example providing individuals (90) with the ability to pre-order goods and/or services from mobile vendors (30). In this regard, once an individual (90) has selected a particular mobile vendor (30) of interest, they may be prompted to select additional information relating to the business offering of the mobile vendor (30), eg. a menu in instances where the mobile vendor (30) sells food. The menu may be interactive and enable individuals (90) to remotely pre-order food and/or drink from the mobile vendor (30) for pickup at a particular date and time, and payment in respect of such orders may also be made in advance via the software application (40). The abovementioned communication facility may also be used to enable mobile vendors (30) to communicate with individuals (90) who have made pre-orders, including in relation to any delays with their order, recommended pick up time, and adjustments to the order, pick-up time, etc.

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method for alerting individuals regarding the proposed presence of a mobile vendor at a specific geographic location at a particular date and time, the method comprising:
receiving, by one or more processors, information from a plurality of mobile vendors comprising:
details sufficient to identify each mobile vendor,
goods and/or services provided by each mobile vendor;
information for populating a multi-access calendar relating to the proposed presence of each mobile vendor at specific geographic locations on particular days and times;
receiving, by one or more processors, information from one or more individuals comprising:
details of one or more mobile vendors of interest,
goods and/or services of interest, from goods and/or services offered for purchase by each of the registered mobile vendors of interest;
enabling, by one or more processors, each of the one or more individuals to view the multi-access calendar populated with information regarding the proposed presence of mobile vendors of interest, and to record their interest in goods and/or services proposed to be offered by the mobile vendor(s) of interest at a specific geographic location on a particular day and time;
providing, by one or more processors, prior to the individual(s) submitting an order for goods and/or services, one or more reports to the mobile vendors regarding any recorded interest from individuals with respect to goods and/or services proposed to be offered by the mobile vendors for purchase at specific geographic locations on particular days and times;
enabling, by one or more processors, the mobile vendors to adjust, in the multi-access calendar, the information regarding their proposed presence at specific geographic locations on particular days and times based upon receipt of the one or more reports regarding recorded interest from the individuals with respect to the goods and/or services proposed to be offered for purchase, wherein any adjustment(s) made by the vendor regarding any one or more of the location, date and time of a proposed presence are reflected in the multi-access calendar viewable by the one or more individuals in substantially real-time; and
automatically notifying, by one or more processors, the individuals who recorded their interest in attending a mobile vendor site at a specific geographic location at a proposed date and time regarding any adjustment made by the vendor with respect to any one or more of the location, date and time.

2. The method of claim 1, wherein based on an adjustment by the vendor regarding any one or more of the location, date and time, the method further comprises:
providing, by one or more processors, the individual with one or more alternative proposed presences of the mobile vendor at an alternative geographic location and/or an alternative date and/or time.

3. The method of claim 1, wherein the one or more reports provided to mobile vendors regarding any recorded interest with respect to goods and/or services proposed to be offered by the mobile vendors comprises an indication of the number of individuals who have recorded their interest with respect to goods and/or services proposed to be offered by the mobile vendors for purchase at specific geographic locations on particular days and times.

4. The method of claim 3, wherein the one or more reports further comprises recommendations in relation to any one or more of:
adjustments recommended to the location, date and/or time based on the number of individuals who have recorded their interest;
adjustments recommended to the location, date and/or time, based on historical data,
adjustments recommended to the location, date and/or time based on information received from one or more external sources.

5. The method of claim 4, wherein the information received from the plurality of mobile vendors further comprises the location(s) they are required to visit to (i) obtain stock, and (ii) attend in accordance with recorded interest from registered users at specific geographic locations, the one or more reports further comprising recommendations in relation to any one or more of:
an amount of stock to purchase to cater for at least the number of individuals who have recorded their interest,
an amount of stock to purchase that accounts for any adjustments made by the vendor to the location, date and/or time, and
travel routes representing the most efficient travel path between said locations.

6. The method of claim 4, wherein the historical data comprises stored data relating to previous selections of location, date and/or time by the mobile vendor, and the relative success regarding said selections including in relation to at least the number of individuals who purchased goods and/or services from the mobile vendor and/or the quantum of goods and/or services purchased.

7. The method of claim 4, wherein the information received from one or more external sources relate to external factors that could influence the number of visitors to the mobile vending site at the specified location and at the particular date and/or time.

8. The method of claim 7, wherein the information received from the one or more external sources comprises any one or more of:
weather information upon which the likelihood of an adverse weather event to occur at the specified location at the particular date and/or time is determined,
event information upon which the propensity for an event held at or adjacent the specified location at the particular date and/or time is determined,
works information upon which the propensity for works, comprising any construction work, proposed to be carried out at, or in close proximity to, the specified location at the particular date and/or time is determined.

9. The method of claim 1, wherein the information received from the one or more individuals further comprising a geographic location of the one or more individuals.

10. The method of claim 9, further comprising:
providing, by one or more processors, individuals who have previously expressed interest in a mobile vendor and/or the goods and/or services of the mobile vendor with an alert or notification regarding the proposed presence of the mobile vendor in instances where the mobile vendor's proposed presence comprises a location within a predetermined vicinity of the individual's geographic location.

11. The method of claim 10, wherein the alert or notification is any one or more of an email, text message, and/or push notification.

12. The method a of claim 1, wherein the information provided by the plurality of mobile vendors comprises a category of mobile vendor, and a category of goods and/or services provided by the mobile vendor.

13. The method of claim 12, further comprising:
providing, by one or more processors, individuals with a search facility to enable keyword searching for mobile vendors, wherein the search facility enables filtering of search results according to any one or more of:
category of mobile vendor,
goods and/or services offered by mobile vendors,
category of goods and/or services,
a date on which the individual proposes to purchase goods and/or services from a mobile vendor,
a time period during which the individual proposes to purchase goods and/or services from a mobile vendor,
a time at which the individual proposes to purchase goods and/or services from a mobile vendor, and
location, date and/or time of the proposed presences of mobile vendors.

14. A The method of claim 1, wherein the multi-access calendar is viewable by the individuals, and thereby enables the individuals to view the proposed presence(s) of mobile vendors of interest comprising any adjustments to the proposed presences, the multi-access calendar further enabling the individuals to access an associated interactive map that displays a geographic area comprising the location of the proposed presence(s) reflected in the multi-access calendar, wherein any adjustment made by the vendor in relation to the location of the proposed presence(s) is also reflected in the interactive map in substantially real-time.

15. The method of claim 14, wherein the interactive map further enables individuals to search for additional mobile vendors having proposed mobile vending presences within a particular geographical area, including by allowing the individual to manually adjust the geographical area viewable on a display of a data communications device associated with the individual, and to search within the geographical area currently displayed.

16. The method of claim 1, further including comprising:
providing, by one or more processors, a sharing facility allowing individuals to share with other individuals any one or more of:
interest in goods and/or services of a mobile vendor at a specified geographic location and at a particular day and time,
an intention to purchase goods and/or services from a particular mobile vendor at a specified geographic location and at a particular day and time, and
their experiences with purchasing goods and/or services from particular mobile vendors.

17. A computer-implemented system for alerting individuals to the proposed presence of a mobile vendor at a specific geographic location at a particular date and time, the system comprising one or more processors operable to:
receive information from a plurality of mobile vendors comprising:
details sufficient to identify each mobile vendor,
goods and/or services provided by each mobile vendor;
information for populating a multi-access calendar relating to the proposed presence of each mobile vendor at specific geographic locations on particular days and times;
receive information from one or more individuals comprising:
details of any one or more mobile vendors of interest,
goods and/or services of interest, from goods and/or services offered for purchase by each of the registered mobile vendors of interest;
enable, prior to the individual(s) submitting an order for goods and/or services, each of the one or more individuals to view the multi-access calendar populated with information regarding the proposed presence of mobile vendors of interest, and to record their interest in goods and/or services proposed to be offered by the mobile vendor(s) of interest at a specific geographic location on a particular day and time;
provide one or more reports to the mobile vendors regarding any recorded interest from individuals with respect to goods and/or services proposed to be offered by the mobile vendors for purchase at specific geographic locations on particular days and times;
enable the mobile vendors to adjust, in the multi-access calendar, the information regarding their proposed presence at specific geographic locations on particular days and times based on receipt of the one or more reports regarding recorded interest from the individuals with respect to the goods and/or services proposed to be offered for purchase, wherein any adjustment(s) made by the vendor regarding any one or more of the location, date and time of a proposed presence are reflected in the multi-access calendar viewable by the one or more individuals in substantially real-time; and
automatically notify the individuals who recorded their interest in attending a mobile vendor site at a specific geographic location at a proposed date and time regarding any adjustment made by the vendor regarding one or more of the location, date and time.

18. A non-transitory computer-readable medium comprising computer instruction code that, when executed on a computer, causes one or more processors to perform the steps of:
receiving information from a plurality of mobile vendors comprising:
details sufficient to identify each mobile vendor,
goods and/or services provided by each mobile vendor;
information for populating a multi-access calendar relating to the proposed presence of each mobile vendor at specific geographic locations on particular days and times;
receiving information from one or more individuals comprising:
details of one or more mobile vendors of interest,
goods and/or services of interest, from goods and/or services offered for purchase by each of the registered mobile vendors of interest;
enabling, prior to the individual(s) submitting an order for goods and/or services, each of the one or more individuals to view the multi-access calendar populated with information regarding the proposed presence of mobile vendors of interest, and to record their interest in goods and/or services proposed to be offered by the mobile vendor(s) of interest at a specific geographic location on a particular day and time;
providing one or more reports to the mobile vendors regarding any recorded interest from individuals with respect to goods and/or services proposed to be offered by the mobile vendors for purchase at specific geographic locations on particular days and times;
enabling the mobile vendors to adjust, in the multi-access calendar, the information regarding their proposed presence at specific geographic locations on particular days and times based on receipt of the one or more reports regarding recorded interest from the individuals with respect to the goods and/or services proposed to be offered for purchase, wherein any adjustment(s) made by the vendor regarding any one or more of the location, date and time of a proposed presence are reflected in the multi-access calendar viewable by the one or more individuals in substantially real-time; and
automatically notifying the individuals who recorded their interest in attending a mobile vendor site at a specific geographic location at a proposed date and time regarding any adjustment made by the vendor regarding any one or more of the location, date and time.

19. (canceled)
